(19) United States
(12) Patent Application Publication
(10) Pub. No.: US 2006/0161314 A1
(43) Pub. Date: Jul. 20, 2006

(54) Software defined radio unit and vehicular information system

(75) Inventor: Tetsuroo Honmura, Kokubunji (JP)

Correspondence Address: MILES & STOCKBRIDGE PC, 1751 PINNACLE DRIVE, SUITE 500, MCLEAN, VA, 22102-3833, US

(73) Assignee: Hitachi, Ltd.

(21) Appl. No.: 11/071,366

(22) Filed: Mar. 4, 2005

(30) Foreign Application Priority Data
Jan. 19, 2005 (JP) 2005-011104

(51) Int. Cl. G05D 1/00

(52) U.S. Cl. 701/1; 717/168

(57) ABSTRACT

An automatic upgrading method in which, when software is downloaded and upgraded to change a specification of a software defined radio system on a vehicular system, convenience to a user who receives services using wireless communication is not reduced and error operations of the vehicular system is inhibited, is provided. A state in which a vehicle is not used is the most appropriate for the upgrade. It is determined whether a key is removed. When the key is removed, the download is executed using wireless communications. After that, a software defined radio system and a car navigation system are stopped. The upgrade and test operation are executed. When the test result is good, the software defined radio system and the car navigation system are restarted.

### CLAIM OF PRIORITY

The present invention claims priority from Japanese application JP 2005-011104 filed on Jan. 19, 2005, the content of which is hereby incorporated by reference into this application.

### FIELD OF THE INVENTION

The present invention relates to a software defined radio unit which can change a specification of a radio unit by use of a software and to a vehicular information system. In particular, the present invention relates to a technique for upgrading a wireless communication specification by changing software.

### BACKGROUND OF THE INVENTION

Recently, along with the popularization and development of information systems, various wireless communication specifications have been produced. A software defined wireless communication systems which achieves the signal processing of transmission and reception required for wireless communication by use of software and accommodates these various wireless communication specifications by changing software, has been proposed.

An invention of the Japanese Patent Laid-Open No. 2001-5671 is aimed to rapidly download system software such as an operating system during running of a vehicle and to automatically download the software for the public. Version information about vehicular software is acquired via wireless communication. In accordance with this information, it is determined whether the software is to be upgraded. Additionally, in accordance with information about a vehicular system acquired via wireless communication, it is determined whether the vehicular system meets an operating condition of the software to be upgraded. When the results of these determinations meet a condition of the upgrade, new software is downloaded. A server and terminals cooperatively and automatically execute this series of the determinations and processes via wireless communication.

In an invention of the Japanese Patent Laid-Open No. H11 (1999)-27749, it is an object to provide, to users, appropriate information for determining, before update and addition of software for a terminal, whether the upgrade and addition are to be executed. In the system of the Japanese Patent Laid-Open No. H11-277, a request for an upgrade and information about software and hardware mounted to a vehicle are transmitted from the vehicle to an information center. In accordance with this information, the information center selects software to be upgraded, and transmits a demonstration image which shows a function achieved by the software to be upgraded. In accordance with the demonstration image, the user permits the download. Additionally, the information center transmits, to the vehicle, the necessity of changing the hardware associated with the upgrade. This information is displayed to the user. The user determines the execution of the download in accordance with the information.

### SUMMARY OF THE INVENTION

When a software defined radio is mounted to a vehicle, problems arise in the software upgrading method because the upgrade is executed in a vehicle, which is a mobile system and a product for the public inexperienced in computers.

(1) How does the user acquire information about the software version and system in the mobile vehicle to determine whether the software is to be upgraded and can be upgraded?

(2) How is the software upgraded without reducing convenience to the user who receives services during running of the vehicle?

(3) An error operation occurred in the basic function during running of the vehicle may cause an accident. How is the error operation due to the upgrade inhibited?

(4) How do the public inexperienced in computers recognize effects of the software?

These problems are common not only in software defined radio systems but system software such as operating systems targeted for mobile systems. The problem of (4) may occur in software other than the system software for mobile systems.

In the method disclosed in the Japanese Patent Laid-Open No. 2001-5671, a series of the determinations and processes of the download and upgrade are automatically executed, so that the convenience to the user is considered to some degree because the currently used services are not reduced.

However, in the solution disclosed in the Japanese Patent Laid-Open No. 2001-5671, a problem remains in terms of convenience to the user and the inhibition of error operation. The problem arises particularly in software defined radio units. The download herein means that software is stored on a secondary storage medium such as a hard disk. The upgrade herein means that a computer is set up to enable downloaded software to operate on the computer.

First, the problem is described in terms of convenience to the user. The download and upgrade take several minutes to about ten minutes. Particularly in the upgrade, the computer needs to be temporarily stopped, and thus the currently used services needs to be temporarily stopped. Since a mobile wireless communication system used for example in a mobile phone needs to notify a position of its terminal to the base station, the wireless communication system always operates. Accordingly, to stop this operation, usage of the user needs to be considered. To keep convenience to the user as much as possible, it is necessary to execute the download and upgrade in consideration of usage of the user.

Next, a problem is described in terms of error operations. The software used in software defined radios belongs to the category of basic system software which directly controls hardware. Accordingly, unless the software is used after it is tested whether the software normally operate, a error operation in which not only a newly added wireless communication function but also other functions do not normally operate may occur. In consideration of usage of the user as well as of the convenience, it is necessary to execute the upgrade in which error operations are inhibited when software in continuously operating wireless communications is to be upgraded.

In the Japanese Patent Laid-Open No. H11-27749, the problems of (1) and (4) are described, but the problems of (2) and (3) are not considered.

An object of the invention is to provide a software defined radio unit in which a software defined wireless communication system in a mobile system can be automatically upgraded without reducing convenience to the user and with inhibiting error operations of a vehicular system.

The summary of a representative invention of inventions disclosed in this application is explained below.

A software defined radio unit in a vehicular system which can define a wireless communication specification by use of software and a computer which controls a wireless communication system, includes a function changing a wireless communication specification and a usage notification function which receives information about the vehicle state and notifies the information to the computer. The former function is executed by the computer, and changes a specification of the wireless communication system when the vehicle state is in a non-use state.

Without reducing convenience to a user who receives services and with inhibiting error operations of the vehicular system, the software defined wireless communication system in a mobile system can be automatically upgraded. Accordingly, effectiveness of computers can be maintained in mobile products for the public inexperienced in computers.

### BRIEF DESCRIPTION OF THE DRAWINGS

FIG. 1 shows a structure of a vehicular system including a software defined radio system SDRS in one embodiment of the present invention.

FIG. 2 shows a structure of the SDRS of one embodiment of the present invention.

FIG. 3 is a flowchart showing a reception procedure of the SDRS and a CNS of one embodiment of the present invention.

FIGS. 4A and 4B are diagrams for selecting a timing at which wireless communication software of one embodiment of the present invention is upgraded.

FIG. 5 shows an overall system structure of one embodiment of the present invention.

FIG. 6 is a flowchart for upgrading the wireless communication software of one embodiment of the present invention.

FIG. 7 is a flowchart for a download process 6042 of the wireless communication software of one embodiment of the present invention.

FIG. 8 shows a data structure for downloading the wireless communication software of one embodiment of the present invention by each block.

FIG. 9 is a flowchart showing a process of an interruption program when a key of one embodiment of the present invention is inserted.

FIG. 10 is a former part of a flowchart of a data center and vehicular system for upgrading the wireless communication software of one embodiment of the present invention.

FIG. 11 is a latter part of a flowchart of a data center and vehicular system for upgrading the wireless communication software of one embodiment of the present invention.

### DETAILED DESCRIPTION OF THE PREFERRED EMBODIMENTS

Representative embodiments according to the present invention are explained below in detail in reference to the drawings. In the following, components having the same reference numerals and symbols are the same or similar.

First, the basic concept presupposed by the embodiments of the invention is described. In the present invention, by changing a specification of a wireless communication system when a vehicle is in a non-use state, the above problems are solved. This is because a user does not use services or a wireless communication when the vehicle is in a non-use state, and because it is determined that the user is likely not to use the services or the wireless communication for a while in the future, for example, for about ten minutes. During this non-use state, the wireless communication software is changed.

The vehicle in a non-use state means that the vehicle is not actually used, namely, the vehicle is not running as a mobile system or not in a preparatory stage of the running, and that the vehicular accessories are not used even when the vehicle is stopped. The typical example where the vehicle is in a non-use state is such that an engine key (also called an ignition key) is removed from a key cylinder. In the case where the user carries an engine key having a wireless communication function, the vehicle is running or in a preparatory stage of the running even if the key is not inserted to the key cylinder, or the vehicle is used when the vehicular accessories are used.

On the other hand, when the user is in the vehicle in which a room lamp is turned on in the state where only a door lock key is inserted and the engine key is removed from the key cylinder, the vehicle is in a non-use state, namely, not in an in-use state.

In the following, the summary of a system of the present invention which detects usage of a vehicle to download and upgrade wireless communication software is described. Hereinafter, the term “key” means an engine key unless it is especially distinguished.

First, a system structure of a vehicular terminal includes a car navigation system CNS which executes an overall control, a software defined radio system SDRS which executes wireless communication operation in cooperation with the CNS, and a key sensor module KS which detects whether a key used as a usage detecting function which detects usage of a vehicle is removed.

Next, a usage notification function and a wireless communication specification changing function stored in control software in the CNS are explained. The control software in the CNS needs to download wireless communication software and a test program when receiving, from the usage detecting function, a notification that a vehicle is in a non-use state.

Next, after the download of the software is finished in the control software, the CNS and SDRS need to stop wireless communication operation to install and test the wireless communication software.

Finally, after the test is appropriately finished in the control software, the wireless communication operation of the CNS and SDRS needs to be restarted.

In the following, the embodiment is specifically explained.

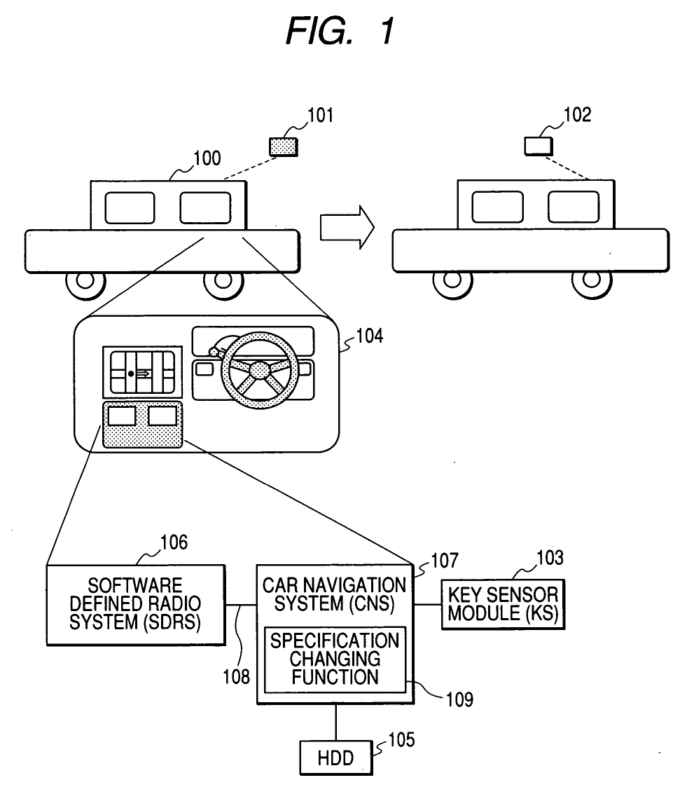

FIG. 1 shows an example of a telematics terminal 104 forming an information system mounted to a vehicle 100. Particularly, FIG. 1 shows the example where a software defined radio system (SDRS) 106 forming a part of the telematics terminal is applied to a system.

In the SDRS 106, when a wireless communication specification is changed in the future and when an optimum wireless communication specification is changed when a vehicle is running in accordance with installation and wireless communication wave conditions of wireless communication base stations 101 and 102, the wireless communication specification needs to be flexibly switched in accordance with these changes.

The wireless communication specifications to be switched include, for example, a wireless LAN, ETC (DSRC), and terrestrial DTV communications.

In the following, first, a structure of a software defined radio unit having this SDRS as a main component and preferable timings for the upgrade are described. Next, a structure of an overall system for achieving the upgrade is described.

[1. Structure of Software Defined Radio Unit]

In FIG. 1, the telematics terminal 104 includes a function (a device) as a host computer, and executes controls of the SDRS, including the activation and termination of the software defined radio system (SDRS) 106. The telematics terminal 104 processes information about the vehicle navigation system (CNS) 107, such as images and sounds, and uses the software defined radio system (SDRS) 106 to communicate information data with the CNS 107. The CNS 107 includes the wireless communication specification changing function 109 for executing determinations and processes to change a specification of the wireless communication defined system. The wireless communication specification changing function 109 (or the software changing function) is achieved by a program which is loaded on a memory of a computer and which executes a predetermined procedure, and determines whether a specification of the SDRS is to be changed in accordance with information about usage of the vehicle. When the change is necessary, a specification of the SDRS is changed to meet usage of the vehicle.

An interface 108 between the CNS 107 and SDRS 106 uses a standard data communications interface such as USB.

A hard disk driver (HDD) 105 stores information data acquired, for example, via a wireless communication. The test program and wireless communication software for the SDRS 106 are also temporarily stored in the hard disk driver (HDD) 105.

The key sensor module (KS) 103 detects a state of a key and an operation state of the key, and includes an inverter circuit for AD converting a detected signal. The operation states of the key include: (a) a state where a key is removed from a key cylinder; (b) a state where a key is only inserted into a key cylinder; (c) a state where a key closes an electrical circuit between a vehicular accessory load and a battery; (d) a state where a key closes each electrical circuit between an accessory load and engine ignition load, and a battery; (e) a state where a key closes each electrical circuit between a battery, and an engine activation load as well as the accessory load and ignition load. In this embodiment, when the operation state of the key is in (a) to (e), the vehicle is determined to be used.

The key sensor module (KS) 103 also includes a function for detecting an operation state of an engine key having a radio unit.

When the vehicle is an electric vehicle, the key sensor module (KS) 103 needs to detect a state which corresponds to the above (d) and (e) and in which a key closes each electrical circuit between a battery and a generator motor load for running the vehicle, in addition to the above (a), (b), and (c), as the operation state of the key.

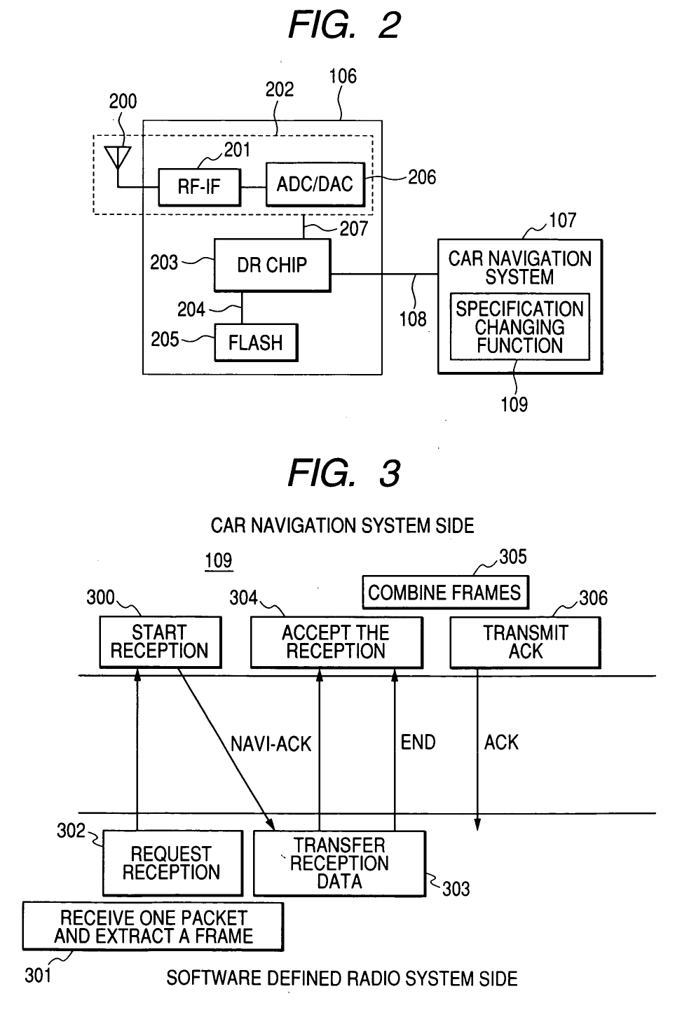

FIG. 2 is a block diagram showing an internal structure of the SDRS 106. Wireless communication data is digitalized to digital data via an analog process portion 202 in a dynamic reconfigurable (DR) chip 203 for highly efficiently executing digital processes, and transferred to the CNS 107 via the interface 108. To transmit the data, the reverse path is used. The DR chip is a high efficient chip including, as a main component, an operation accelerator in which ALUs are arranged in an array and which is directed for signal processing.

The analog process portion 202 includes an antenna 200, an RF-IF circuit 201, an analog-to-digital converter (ADC), and a digital-to-analog converter (DAC). The ADC is used for the reception. The DAC is used for transmission.

A FLASH 205 of the digital process portion is used for storing various programs.

Next, in the wireless communication specification changing function 109, how the SDRS 106 transfers wireless communication data with the CNS 107 is described below using, as an example, the case where the wireless communication data is received, with reference to FIG. 3.

In case of reception shown in FIG. 3, the SDRS 106 executes one packet reception/frame extraction 301, and executes a reception request 302 for requesting the CNS 107 to accept reception data. The CNS 107 transfers Navi-Ack to the SDRS 106 to execute a reception start 300. After receiving the Navi-Ack, the SDRS 106 starts a reception data transfer 303 to transfer reception data of one frame to the CNS 107. The CNS 107 starts a reception acceptance 304. After transferring all the reception data to the CNS 107, the SDRS 106 transfers an END showing an end to the CNS 107. After that, the CNS 107 executes a frame composition 305, and simultaneously transfers an ACK signal to be returned to a transmission station to the SDRS 106 (ARK transmission 306). The ARK transmission is a sort of transmission. Operation of the transmission is not described here. The transmission is executed by a procedure reverse to the reception.

As described above, the software defined radio system described here executes a reception or transmission of one frame in the SDRS 106, and composes or decomposes the frame in the CNS 107. The SDRS 106 and CNS 107 form the software defined radio system. In addition to such a structure, a structure where a frame is decomposed or decomposed in the SDRS 107 can be considered. Also in this case, the CNS 107 operates as a host computer for instructing activation and termination of the software defined radio system and for monitoring the state. Accordingly, in the wireless communication operation, the CNS 107 needs to operate. The operation of the SDRS 106 may cause a error operation of the CNS 107.

[2. Timing for Upgrade]

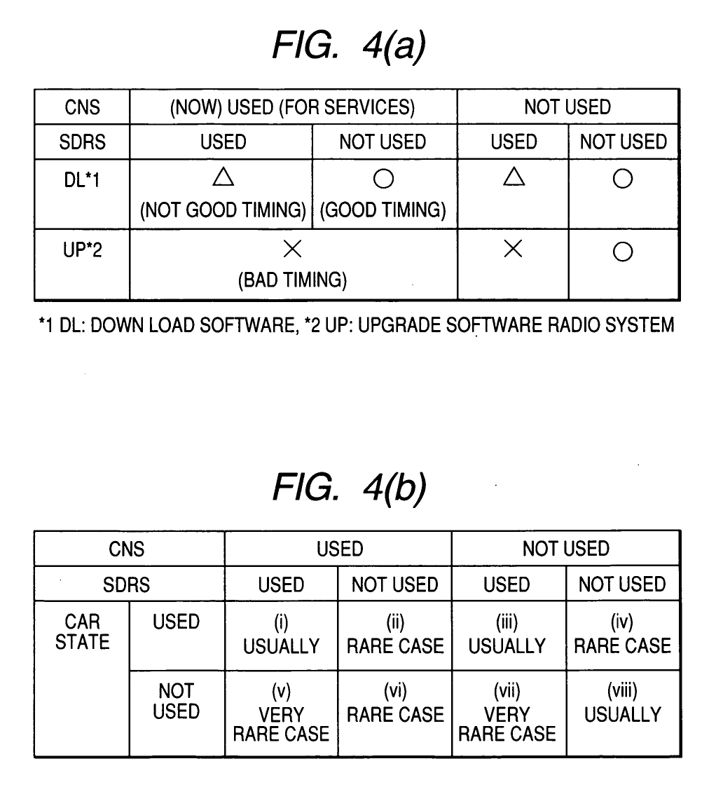

In the following, with reference to FIGS. 4A and 4B, timing at which the wireless communication specification changing function 109 executes the download and upgrade to inhibit error operations without reducing convenience to the user, is described.

FIG. 4A shows timings appropriate for the download (DL) and upgrade (UP) in accordance with whether a user now uses the CNS 107 and SDRS 106 as services. FIG. 4B shows the vehicle states when usage (in-use state) of services of the CNS 107 and SDRS 106 shown in FIG. 4A is likely to occur. From FIG. 4A, timings appropriate for the download and upgrade can be acquired. From FIG. 4B, vehicle states at the appropriate timings can be known.

Before the basis of FIGS. 4A and 4B is described, the conclusion obtained from FIGS. 4A and 4B is described. The DL is appropriately executed at a timing at which the SDRS 106 is not used (lines where SDRS is “not used” in FIG. 4A) regardless of whether the CNS 107 is used. This state is most likely to occur when a vehicle is not used (cells on lines where SDRS is “not used” and on rows where “Car state” is “not used” in FIG. 4B). The UP is appropriately executed at a timing at which the CNS 107 and SDRS 106 are not used (lines where CNS and SDRS are “not used” in FIG. 4A). This state is most likely to occur when a vehicle is not used (cells on lines where CNS and SDRS are “not used” and on rows where “Car state” is “not used” in FIG. 4B).

Therefore, timings at which a vehicle is not used are detected, and the DL and UP are appropriately executed at these timings. After this detection, the download is appropriately executed in a state where the SDRS 106 does not operate or in a state the CNS 107 does not operate. The upgrade is appropriately executed in a state where the CNS 107 does not operate.

In the following, the basis of FIGS. 4A and 4B from which the above conclusion is derived is described.

First, FIG. 4A is explained. In FIG. 4A, “used” shows that the CNS 106 and SDRS 107 are used to receive services, and “not used” shows that the CNS 106 and SDRS 107 are not used. As described in [1.], when the SDRS 106 is used for wireless communication operation, the CNS 107 is used in some form. The usage of the CNS 107 shown in FIG. 4A shows usage other than wireless communication operation usage. Circles shown in rows of the DL and UP show timings at which the download or upgrade is appropriately executed in terms of convenience to a user and inhibition of error operations. Triangles show timings at which the download or upgrade is not so appropriate to be executed but this execution does not have a very bad influence. Crosses show bad timings.

A timing at which the SDRS 106 is not used is good for the download (DL). A timing at which the SDRS 106 is used is not very good for the download (DL). This is because the download requires wireless communication to reduce convenience to a user. On the other hand, whether the timing is good or bad does not depend on whether the CNS 107 is used. This is because process amount of the CNS 107 used for wireless communication operation is small, and the CNS 107 can be considered to be designed on the premise that the CNS 107 downloads various data by use of wireless communication, so that the download of wireless communication software may be assumed not to obstruct other services.

On the other hand, a timing at which the CNS 107 or SDRS 106 is used is bad for the upgrade (UP). To execute the upgrade, it is necessary that a test is executed after the install to confirm that the software normally operates. On the other hand, when a software defined radio operates, operation of the CNS 107 as well as operation of the SDRS 106 is required, as described in [1.]. Accordingly, in consideration of convenience to a user and inhibition of error operations, services now executed using the CNS 107 and SDRS 106 need to be stopped. As a result, a state in which services are provided using the CNS 107 and SDRS 106 is a bad timing for the upgrade (UP).

Next, FIG. 4B is explained.

When a vehicle is used (rows where “Car state” is “used”=i to iv), the SDRS 106 is usually used (“usually”=i, iii) regardless of whether the CNS 107 is used. This is because vehicular services include telematics services using wireless communication as main services, such as broadcasting. Therefore, a state in which the SDRS 106 is not used is a rare case (“rare case”=ii, iv).

Next, a state in which a vehicle is not used (rows where “Car state” is “not used”=v to viii) is described as a state when the CNS 107 operates and a state when the CNS 107 does not operate.

First, the state when the CNS 107 operates (“used”) is described. This state may rarely occur in a case in which some service is received using the CNS 107 or in a case in which data is stored in the HDD 105. The service may be actually considered to be a service for automatically releasing a door lock of a vehicle by use of an electronic key when a key is left in the locked vehicle. This service may be rarely required. In this case, the SDRS 106 using wireless communication for mobile systems does not operate. In the data storage, no wireless communication operation is required. Accordingly, also at this time, the SDRS 106 does not operate. Therefore, when the CNS 107 is “used”, a case in which the SDRS 106 is “not used” is “rare case” (=vi). On the other hand, a case in which the SDRS 106 is “used” is actually hardly considered. However, considering possibility that a service corresponding to such a case will appear in the future, the case is “very rare case” (=v).

Next, a case in which the CNS 107 does not operate (“not used”) is described. At this time, like the case in which the CNS 107 operates, a case in which the SDRS 106 is used (“used”) is hardly considered in existing services, and thus is a “very rare case” (=vii). On the other hand, a case in which the SDRS 106 does not operate (“not used”) is a usual case (“usually”=viii).

The point to be noticed about the above described two cases, namely, the case in which the CNS 107 operates and the case in which the CNS 107 does not operate is as follows. The case in which the SDRS 106 is “not used” means that the SDRS 106 is not used for some service or for preparation for the service. The radio unit always maintains a standby state for communications to prepare for external responses. For example, operation for notifying a position uses transmission. Even when not executing this operation, the radio unit executes reception when some data arrive.

The above description is the basis of FIGS. 4A and 4B. As described in the first part of [2.], the DL and UP are preferably executed when a vehicle is not used in accordance with FIGS. 4A and 4B.

Therefore, means for detecting a case in which a vehicle is not used is important. A system structure and process flow for achieving the upgrade in which the DL and UP are combined, including this detection, are described in [3.] and later.

[3. Overall System Structure]

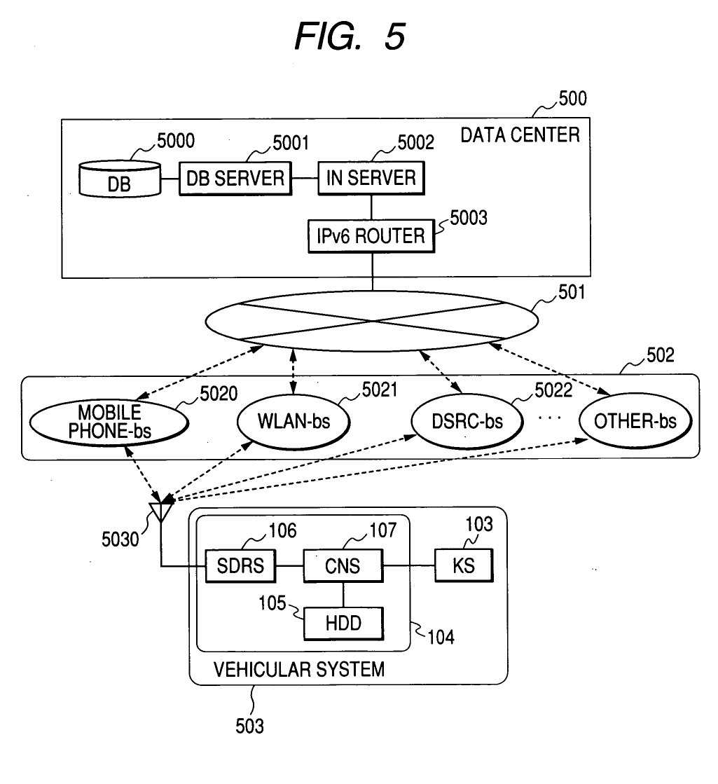

A structure of an overall system including a data center and a vehicular terminal system, which is presupposed by a process flow of the upgrade, is described below with reference to FIG. 5.

The structure achieving the upgrade is divided into four components: a Data Center 500; a backbone 501; wireless communication base stations 502; and a Vehicular System 503. The Data Center 500 is a server of software and content data which are targets of the present invention, and transmits them to the base stations for the download. The backbone 501 is, for example, an optical fiber network and a public line network, and physically mediates data transfer between the server, and various wireless communication base stations and global terminals. The wireless communication base stations 502 mediates transmission and reception between the backbone 501 and various wireless communication terminals. When the wireless communication terminals are in mobile systems, positions of the wireless communication terminals are always monitored so that the optimum wireless communication base station 502 mediates data. The vehicular system 503 includes a telematics terminal 104 which is an implementation of the wireless communication terminal and the key sensor module (KS) 103 which is a main component of the present invention.

The data center 500 includes a database (DB) 5000 for storing data to be downloaded, a DB server (Server) 5001 for controlling data transfer in DB 5000, an Internet server (In Server) 5002 for executing control for the Internet, such as management of addresses for the Internet, and an Internet protocol version 6 router (IPv6 Router) 5003 for transmitting and receiving data in accordance with the control of 5002.

The wireless communication base stations 502 include various types for mobile systems, including a mobile phone base station (Mobile Phone-bs) 5020, a wireless LAN base station (WLAN-bs), and a DSRC base station (DSRC-bs) mainly for freeways. The mobile system selects an optimum wireless communication from these wireless communication base stations to execute communications.

The internal structure and functions of the vehicular system 503 are described in [1.], and therefore not described here. An antenna 5030 transfers wireless communication data with the wireless communication terminals 502. When the frequency bands are different, a plurality of antennas are required. However, since the number of antennas is not the subject of the present invention, the number of antennas is one in this embodiment.

[4. Process Flow for Upgrade]

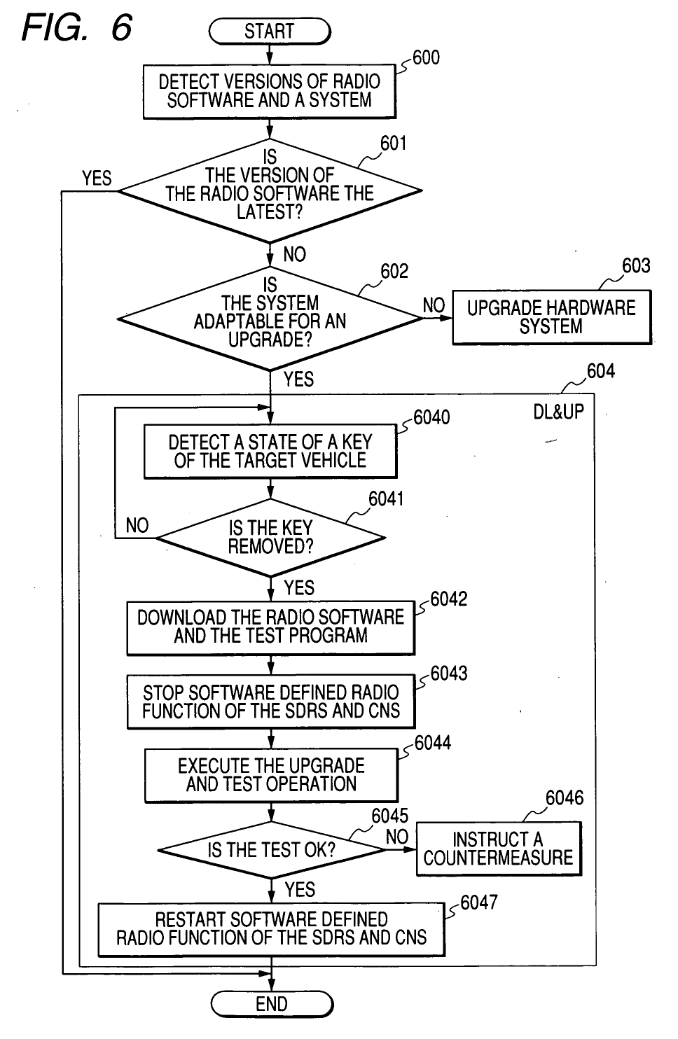

A flowchart of the upgrade by use of the wireless communication specification changing function 109 of the CNS 107 is described below with reference to FIGS. 6 to 11.

FIG. 6 does not exhibit each function of the vehicular system 503, the data center 500, the backbone 501, and the wireless communication base stations 502, but shows the overall process flow.

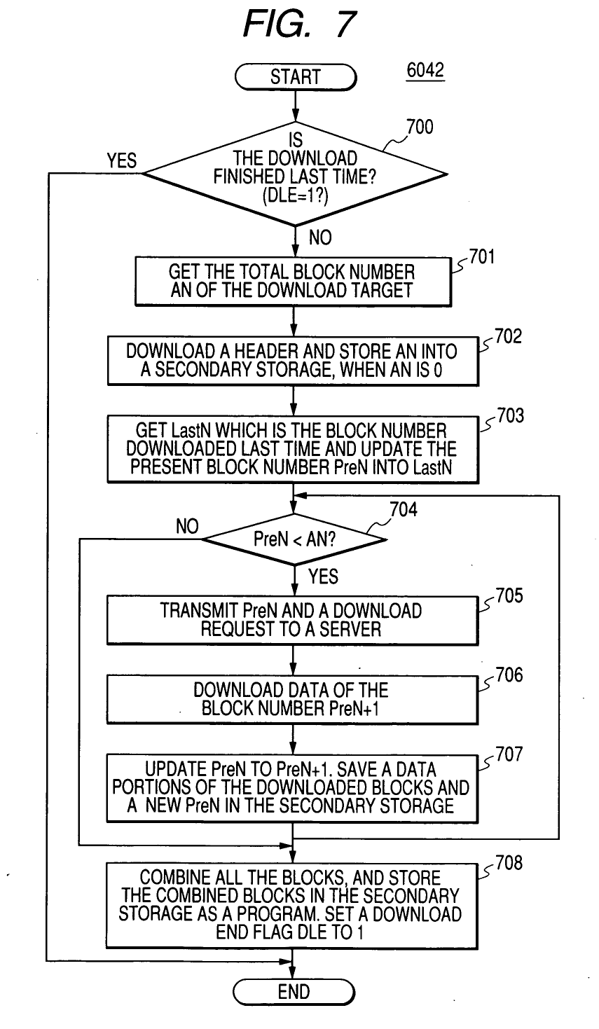

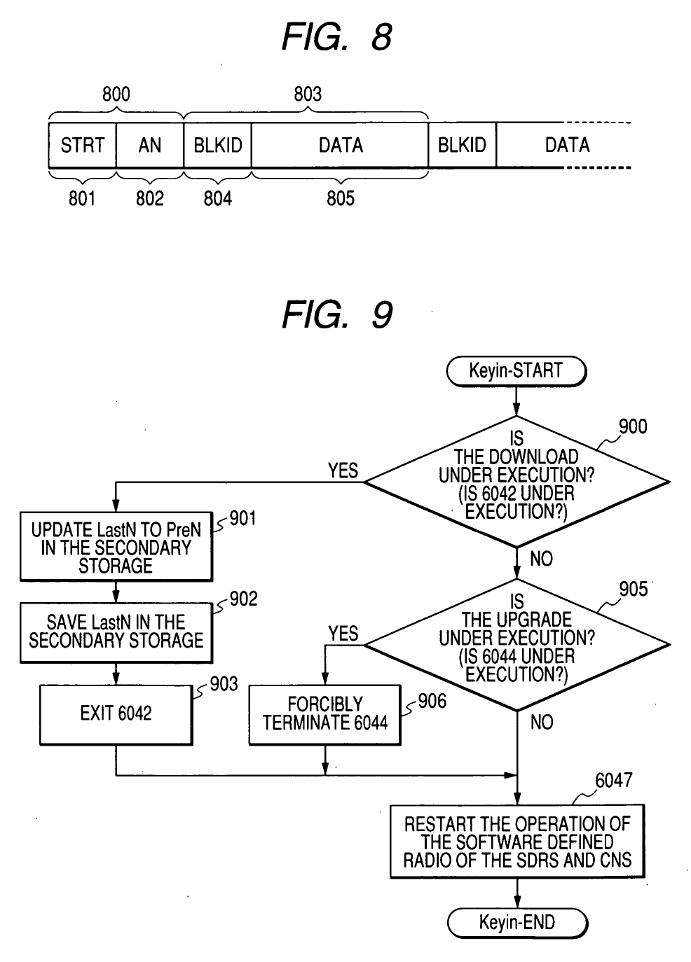

FIGS. 7 to 9 show in detail a process when a key is inserted during the download by the wireless communication specification changing function 109. FIG. 7 shows a detailed flow of a download process 6042. FIG. 8 shows a data structure of wireless communication software to be downloaded. FIG. 9 shows an interruption process executed when a key is inserted.

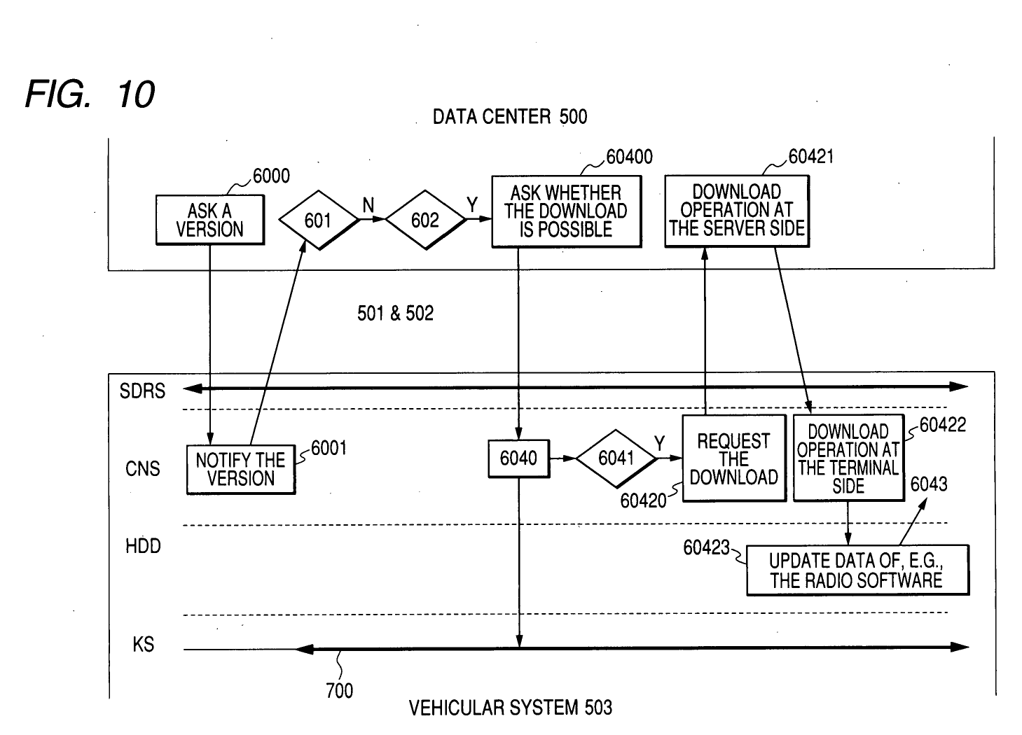

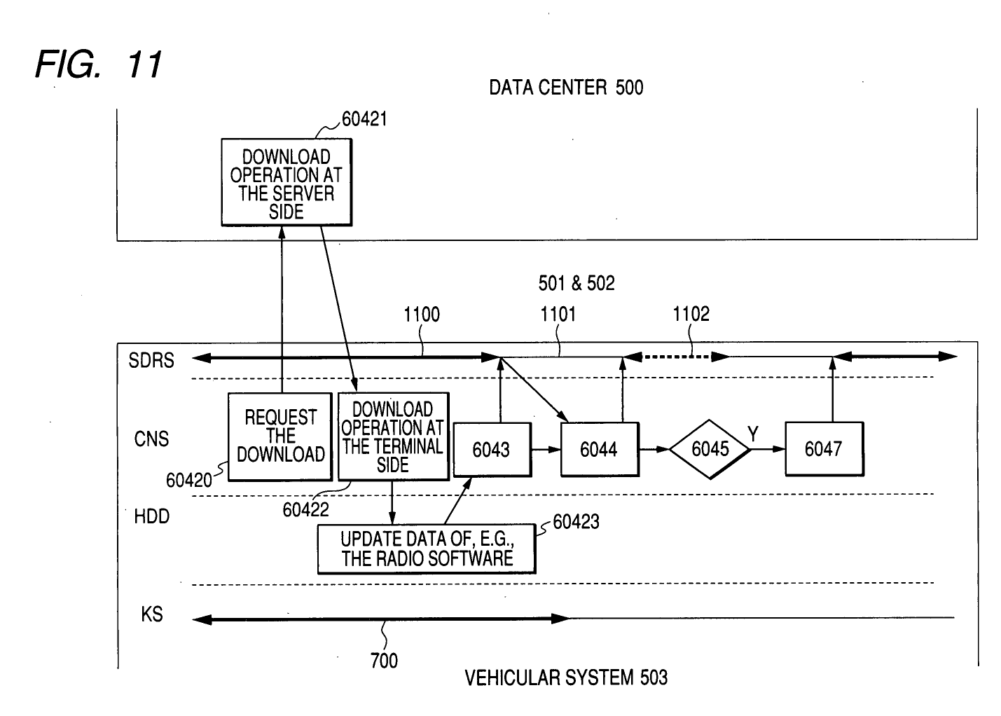

FIGS. 10 and 11 show processes of the vehicular system 503 and data center 500, into which the flowchart of FIG. 6 is divided. Processes of the backbone 501 and wireless communication base stations 502 are not the subject of the present invention, and therefore described as only wireless communication data paths.

[4.1 Overall Process Flow]

With reference to FIG. 6, an overall process flow for changing a wireless communication specification.

First, in Step 600, versions of wireless communication software mounted to the vehicular system 503 and of the vehicular system 503 are detected. The version of the wireless communication software is detected to determine whether the wireless communication software needs to be upgraded to a new version. The version of the vehicular system 503 is detected to determine whether the vehicular system 503 has enough hardware specification to operate wireless communication software of a new version.

In Step 601, it is determined whether the version of the wireless communication software acquired in Step 600 is the latest. When the wireless communication software is the latest, the upgrade is not required. Therefore, the process is completed.

When the version of the wireless communication software is determined not to be the latest in Step 601, it is determined in Step 602 whether a hardware specification of the vehicular system 503 is adaptable for the upgrade in accordance with the version of the vehicular system 503 acquired in Step 600. When the hardware specification is not adaptable for the upgrade, the hardware needs to be upgraded. Accordingly, in Step 603, the user executes the upgrade of the hardware including its system, for example, at a service station.

When the version of the vehicular system 503 is determined to be adaptable for the upgrade in Step 602, the download and upgrade (DL & UP) of the wireless communication software are executed in Step 604. Internal process steps of Step 604 is described below.

First, in Step 6040, a state of a key of a target vehicle is detected. This is to determine a condition that the vehicle is not used, by use of the state of the key in accordance with the conditions described in [2.]. To detect a state in which a vehicle is not used, this state may be determined using means other than the state of the key. For example, the presence of control signals of a system which collectively controls an ignition load, an engine starting load, and an accessory load, such as an engine control unit, is detected. Alternatively, part of their control signals may be directly used. In this embodiment, the method for detecting the key state showing whether the key is inserted or operated is used as the most reliable method.

Next, in Step 6041, it is determined whether the key is removed. In a state in which the key is inserted, the vehicle is determined to be used, and the flow returns to Step 6040.

Next, when the key is removed in Step 6041, the vehicle is determined not to be used, and wireless communication software and a test program for testing a result of the upgrade are downloaded. At this time, before the download, a determination for selecting the best download timing at which the SDRS 106 is not used is more preferably provided in FIG. 4A. In this determination, the CNS 107 determines a state of the SDRS 106. The determination is easily achieved because the CNS 107 of this embodiment functions as the host computer. This is not the subject of the present invention, and therefore is not described in detail here.

Next, in Step 6043, before the upgrade, when the SDRS 106 and CNS 107 are operating, they are stopped. At this time, the presence of a step for enabling the user to determine the stop through the CNS 107 when the SDRS 106 and CNS 107 are used for services is more preferable, but this step is not the object of the present invention. Accordingly, this step is not described here. As described in the last part of [2.], the operation in which the SDRS 106 always maintains a standby state for communications in preparation for external responses is a preparation for services. This operation does not need a determination of the user.

Next, in Step 6044, the upgrade and test are executed. Specifically, software is installed to the SDRS 106 and CNS 107, and it is tested whether wireless communication operation is normally executed.

Next, in Step 6045, it is determined whether the test result is good. When the result is bad, the countermeasure is instructed to the user in Step 6046. As the countermeasure, various methods can be considered. Considering that the countermeasure is directed for the public inexperienced in computer, it may be appropriate that the user is instructed to go to a service station.

Next, when the test result is good in Step 6045, the SDRS 106 and CNS 107 which have been stopped for the upgrade in Step 6047 are restarted. Correctly, their operating states are returned to the states before the upgrade.

[4.2 Process Flow when Key is Inserted]

How to deal with a case in which a user returns to the vehicle and inserts the key during the download and upgrade in the wireless communication specification changing process is described here. It is preferable that the ongoing processes are continued as much as possible when the key is inserted.

First, with respect to the download process 6042, a method for a case in which a key is inserted is described in (1). Next, with respect to the upgrade process 6044, a method for a case in which a key is inserted is described in (2). Finally, with respect to both the download and upgrade, an interruption program for a case in which a key is inserted is described in (3).

(1) Method for a case in which a key is inserted during the download.

As this method, the download is continued and the upgrade is not executed, or the download is stopped. As described in [2.] with reference to FIGS. 4A and 4B, when a currently used software defined radio system, which is usually used while a vehicle is running, cannot be used due to the upgrade, convenience to the user is reduced. To avoid this situation, the upgrade is not executed.

The former method has a demerit that, since a start of primary operation during running of the vehicle is delayed due to the download, the user cannot receive the service until the download is finished. The former method has a merit for error operations that the download can be executed without changing data of wireless communication software. However, the problem about convenience to the user remains.

In the latter method, a method 1 for restarting the download from the beginning when the key is removed next time, and a method 2 for saving the data downloaded last time and downloading data from next to the saved data next time, can be considered. The method 1 has the same merit for manufacturers as in the continuation of the download. However, the download is restarted from the beginning, so that it takes a long real time for the user who frequently stops a vehicle for a short time to finish the download. Accordingly, services for the user by new wireless communication software are delayed. As a result, the problem about convenience to the user remains. In the method 2, wireless communication software is divided into blocks and a number of the block which has been last downloaded is stored. The manufacturer needs to process wireless communication software for the download. The convenience to the user is improved. The method 2 is described below in detail with reference to FIG. 7.

FIG. 7 shows a flow for processing the download process 6042 in accordance with the above method 2. The wireless communication software is divided into blocks, as shown in FIG. 8. The wireless communication software is downloaded by each block. The total number of the blocks is AN. The test data other than wireless communication software can be processed in the same manner as the wireless communication software.

First, a structure of data divided into blocks shown in FIG. 8 is described. The data structure shows an example of a structure of data divided into blocks. Of course, other data structures are possible. In FIG. 8, a program of wireless communication software starts from a header 800, and is divided into blocks 803. The header 800 includes a start flag STRT and AN 802 showing the total number of the blocks. After the header, the blocks 803 are continuously arranged by the number shown by AN. Each block 803 includes a BLKID 804 showing an order of the block and DATA 805 showing data. When the DATA 805 are extracted by the number of the arranged blocks and combined, the program of the wireless communication software is formed.

The data having the structure of FIG. 8 is first downloaded from its header sequentially. Next time, the data is transmitted from the block having a number after the number LastN of the blocks downloaded until the last time.

Next, by use of the data structure of FIG. 8, the process flow for downloading the wireless communication software by blocks is described with reference to FIG. 7. In FIG. 7, means for storing the last downloaded block in the current download is not described. This process is achieved as an interruption program, and described in detail in the after-mentioned (3).

Step 700: It is determined whether wireless communication software is executable after the last download. This determination is such that it is determined whether a flag DLE stored in the secondary storage and showing the finish of the download is 1. When the flag is 1, the download is finished. When the flag is not 1, the download is not finished.

Step 701: The total number AN of blocks to be downloaded is acquired from the secondary storage. When the header 800 has been downloaded until the last time, AN has been set. When the download is first executed this time, AN is 0.

Step 702: When AN is 0, the header is downloaded and AN is stored in the secondary storage.

Step 703: The number LastN of the blocks downloaded until the last time is acquired from the secondary storage. The LastN is stored to a number PreN of the last downloaded block, and the preparation for the download of the blocks is executed.

Step 704: When PreN is smaller than AN, the blocks to be downloaded remain. Accordingly, the download is executed. Otherwise, the download is finished, and the flow goes to Step 708.

Step 705: The number PreN of the blocks which have been downloaded until this time is transmitted to a server which executes the download, and the server is requested to download the next block.

Step 706: The block of the block number PreN+1 is downloaded.

Step 707: PreN is updated to PreN+1. The data portion DATA 805 from the downloaded block is saved in the secondary storage together with new PreN. To download the next block, the flow returns to Step 704 again.

Step 708: After all the blocks are downloaded, DATA 805 of all the blocks are combined to return to the program of the original wireless communication software, and stored in the secondary storage. Simultaneously, the download completion flag DLE is set to 1 and stored. Then, the download process ends.

(2) Method During Upgrade

As this method, the upgrade is stopped. This is because, unlike the download, the upgrade may bring a different result in accordance with the current system state. Of course, when the system is normal, the same result is achieved. When the result is different, the system is abnormal. The system, including and the presence of the abnormality, needs to be tested.

As described above, as the method during the upgrade, the upgrade is immediately stopped. When the key is removed next time, the upgrade is restarted from the beginning. To stop the upgrade, the interruption process is used. This process is described in (3).

(3) Interruption Process

When the key is inserted during the download process 6042 and upgrade process 6044, the processes are stopped. With respect to the download, how far the blocks have been downloaded this time needs to be stored.

The interruption is executed by an interruption notification from the KS 103 to the car navigation system CNS 107. The CNS 107 is not described in detail here because it is not the subject of the present invention. The CNS 107 includes a CPU for executing processes of FIGS. 6 and 7 and an interruption controller for notifying the interruption to the CPU. By use of this mechanism, the interruption is started.

With reference to FIG. 9, a process flow of an interruption program is described.

Step 900: When the interruption notification is received, it is determined whether the download process 6042 is under execution. This determination is possible from a program counter. When the download process 6042 is under execution, Step 901 and later are processed.

Step 901: When the down load process 6042 is under execution, the information LastN required for the next download is updated to PreN stored in the secondary storage in Step 707.

Step 902: The LastN is saved in the secondary storage to prepare for the next download.

Step 903: Exit the download process 6042

Step 905: It is determined whether the upgrade process 6044 is under execution. When the upgrade process 6044 is under execution, Step 906 and later are processed.

Step 906:Exit the upgrade process 6044.

Step 6047: The system is returned to the state before the execution of Step 604 for DL&UP to terminate the interruption program. Specifically, various registers are returned to restart the software defined wireless communication operation of the SDRS 106 and CNS 107.

[4.3 Processes in the Vehicular System and Data Center]

With reference to FIGS. 10 and 11, an overall process flow of the wireless communication specification changing process described in FIG. 6 is described. This flow is divided into the part of the vehicular system 503 and the part of the data center 500. The DB server 5001 mainly executes the series of the processes in the data center 5000. Of course, the Internet server 5002 and IPv6 router 5003 also execute the processes in the data transmission, but their operation is not described here because it is not the subject of the present invention.

First, in response to asking a version 6000 from the data center 500, the CNS 107 in the vehicular system 700 notifies the version to the data center 500 to execute Step 600 of FIG. 6. This process is executed on condition that the CNS 107 stores versions of the wireless communication software and vehicular system.

Next, in the data center 500, the determinations in Steps S601 and S602 are executed. A case in which both results are Yes is shown here. When the determination result in Step 601 is No, the process is terminated. When the determination result in Step 602 is No, the user who possesses the vehicular system is instructed to execute Step 603 in some form. For example, wireless communication notification means is used.

Next, when the wireless communication software and vehicular system are determined to be the targets of the download from the results of Steps 601 and 602, the data center 500 queries about whether the download is permitted in Step 60400.

Next, in response to the query in Step 60400, the CNS 107 obtains a sensing result of the KS 103 to determine whether the key is removed in Steps S6040 and S6041. When the key is removed, namely, the result of Step 6041 is Yes, the CNS 107 transmits a download request to the data center in Step 60420. At this time, a timing at which the SDRS 106 is not used is selected as the optimum timing for the download described in [4.1] before the download, if necessary, by querying the CNS 107.

Next, in response to the download request in Step 60420, the data center 500 downloads the wireless communication software and test program in Step 60421.

Next, the CNS 107 transmits the data downloaded to the vehicular system 503 to the HDD 105 as the terminal side download in Step 60422. In the HDD 105, data of, e.g., the wireless communication software is updated in Step 60423. At this point, Step 6042 is terminated.

Finally, before the upgrade, the software defined wireless communication operation of the SDRS 106 and CNS 107 is temporarily stopped in Step 6043 (in FIG. 11, a state in which the SDRS 106 is shown by the thin line 1101). This stop includes the operation for maintaining the standby state for communications described in the last part of [2.], and means that the SDRS 106 is fully stopped and only the CNS 107 as the host computer enters the standby state. At this time, as described in [4.1], the SDRS 106 or CNS 107 is used for services. When a step for querying the user about the determination by use of the CNS 107 is required, the step is executed before the stop.

Next, in Step 6044, the upgrade and test operation are executed (FIG. 11, dotted line state 1102 during test operation of the SDRS 106). When the test result is good in Step 6045, the software defined wireless communication operation is restarted in Step 6047 (in FIG. 11, thick line state 1100 shows that the SDRS 106 is in the normal operation state).

According to this embodiment, the software defined radio system can be automatically upgraded without reducing convenience to the user and with inhibiting error operations of the vehicular system.

In the above described embodiment of the present invention, the car navigation system CNS executes the overall control including the process for changing the specification of the wireless communication system. When the vehicular information system is provided and has a function for executing the overall vehicle control including the CNS or other than the CNS, the vehicular information system may change the specification of the wireless communication system and other software.

What is claimed is:

1. A software defined radio device comprising:
a wireless communication system changeable a wireless communication specification by use of software; the wireless communication system being loaded into a vehicle;
a computer controlling the wireless communication system;
a wireless communication specification changing function; and
a usage notification function receiving information about usage of the vehicle and notifying the information to the computer,
wherein the wireless communication specification changing function is executed by the computer, and changes a specification of the wireless communication system when the usage of the vehicle is in a non-use state.

2. The software defined radio device according to claim 1,
wherein the information about the usage of the vehicle is information about whether a key of the vehicle is removed.

3. The software defined radio device according to claim 1,
wherein the information about the usage of the vehicle is information about whether an electrical circuit between an accessory load or ignition load of the vehicle and a battery is opened.

4. The software defined radio device according to claim 1,
wherein the wireless communication specification changing function stops operation of the wireless communication system and of the computer before changing the specification of the wireless communication system, and restarts the operation of the wireless communication system and of the computer after confirming that a change of the specification is appropriately completed by executing an operation test after the change of the specification.

5. A software defined radio device comprising:
a wireless communication system loaded into a vehicle;
a computer controlling activation and termination of the wireless communication system;
a software changing function changing software executed by the computer; and
a usage notification function receiving information about a usage of the vehicle and notifying the information to the computer,
wherein the software changing function downloads data about the software by use of the wireless communication system when the usage of the vehicle is in a non-use.

6. The software defined radio device according to claim 5,
wherein information about the usage is information about whether a key of the vehicle is removed.

7. The software defined radio device according to claim 5,
wherein the wireless communication system can define a wireless communication specification by use of software, and
wherein the data is software for changing a specification of the wireless communication system.

8. The software defined radio device according to claim 7,
wherein the software changing function stops operation of the wireless communication system and the computer before changing the specification of the wireless communication system, and restarts the operation of the wireless communication system and the computer after confirming that a change of the specification is appropriately completed by executing an operation test after the change of the specification.

9. The software defined radio device according to claim 7,
wherein the software is divided into a plurality of blocks, and
wherein the software changing function downloads the software by each block.

10. The software defined radio device according to claim 1,
wherein the software is divided into a plurality of blocks, and
wherein the wireless communication specification changing function downloads the software by each block.

11. The software defined radio device according to claim 1,
wherein the wireless communication specification changing function downloads data about the software by use of the wireless communication system when usage of the vehicle is in a non-use, and stops the download when the vehicle is in an in-use state during the download.

12. The software defined radio device according to claim 11,
wherein the wireless communication software is divided into a plurality of blocks, and
wherein the wireless communication specification changing function stores how far the wireless communication software has been downloaded by use of numbers of the blocks of the wireless communication software, and executes the download from a block next to the last downloaded block.

13. The software defined radio device according to claim 12,
wherein data divided into blocks includes a start flag indicating a start of the data, a block number indicating a total number of the blocks, a block order indicating an order of each block, and a plurality of data, and
wherein the plurality of data are extracted by a number of the blocks which are consecutive and combined to form a program of the wireless communication software.

14. The software defined radio device according to claim 1,
wherein the wireless communication specification changing function processes an upgrade by use of the wireless communication system when usage of the vehicle is in a non-use state, and stops the upgrade when the vehicle is in an in-use state during the upgrade to restart software wireless communication operation.

15. The software defined radio device according to claim 14,
wherein the wireless communication specification changing function stops the upgrade by use of an interruption operation to return to a state before an execution of the upgrade, and restarts the stopped upgrade from a beginning when usage of the vehicle is in a non-use state next time.

16. A vehicular information system including a wireless communication system which can define a wireless communication specification by use of software and a computer which controls the wireless communication system, comprising:
a wireless communication specification changing function; and
a usage notification function for receiving information about usage of the vehicle and notifying the information to the computer,
wherein the wireless communication specification changing function is executed by the computer, and changes a specification of the wireless communication system when usage of the vehicle is in a non-use state.

17. The vehicular information system according to claim 16, further comprising:
a usage notification function for detecting usage of the vehicle and for notifying the usage to the computer.

18. The vehicular information system according to claim 17,
wherein the usage notification function includes a sensor for detecting whether a key of the vehicle is removed.

19. A program for generating and outputting information in a software defined radio device having a computer which controls a vehicular wireless communication system which can define a wireless communication specification by use of software, the program comprising:
a step for forming a software defined radio system having a certain specification to process signals of transmission and reception required for wireless communications;
a step for receiving information about usage of the vehicle and for changing a specification of the software defined radio system when usage of the vehicle is in a non-use state; and
a step for stopping the changing process when the vehicle enters an in-use state during the changing process.

20. A program for generating and outputting information in a software defined radio device having a computer which controls a vehicular wireless communication system which can define a wireless communication specification by use of software, the software being divided into a plurality of blocks, the program comprising:
a step for forming a software defined radio system having a certain specification to process signals of transmission and reception required for wireless communications;
a step for receiving information about usage of the vehicle and for changing a specification of the software defined radio system when the vehicle is in a non-use state;
a step for stopping the changing process when the vehicle enters an in-use state during the changing process; and
a step for storing how far the blocks of the software have been downloaded during the changing process.
